(19) United States
(12) Patent Application Publication
(10) Pub. No.: US 2006/0073462 A1
(43) Pub. Date: Apr. 6, 2006

(54) Inline help and performance support for business applications

(75) Inventor: David L. Tetreault, Quincy, MA (US)

Correspondence Address: KENNETH F. KOZIK, ESQ.;HOLLAND & KNIGHT LLP, 10 ST. JAMES AVENUE, BOSTON, MA, 02116, US

(73) Assignee: Aspire, Inc., Arlington, MA (US)

(21) Appl. No.: 11/233,525

(22) Filed: Sep. 22, 2005

Related U.S. Application Data
(60) Provisional application No. 60/612,198, filed on Sep. 22, 2004.
(60) Provisional application No. 60/612,277, filed on Sep. 22, 2004.

(51) Int. Cl. G09B 7/00

(52) U.S. Cl. 434/322

(57) ABSTRACT

Methods and apparatus, including computer program products, for inline help and performance support for business applications. features a computer-implemented method including saving captured display screens of a software application, including cursor movement, in one or more files, annotating the captured display screens with objects that can be set to start and stop at pre-defined intervals, combining the captured display screens and annotations to generate a presentation, streaming video objects in the captured display screens from a server system, and generating testing exercises where results can be displayed and saved.

### CROSS REFERENCE TO RELATED APPLICATIONS

This application claims the benefit of priority from U.S. Application No. 60/612,198, filed on Sep. 22, 2004, and U.S. Application No. 60/612,277, filed on Sep. 22, 2004, the entire content of which are incorporated herein by reference.

### BACKGROUND

The present invention relates to data processing by digital computer, and more particularly to inline help and performance support for business applications.

Computer-based training allows users to learn about various subjects at their own pace. Computer-based training gives users the flexibility to learn at the time and place that is convenient for them. These computer-based training sessions can be delivered through use of removable media such as a floppy diskette or CD-ROM or they can be presented through a computer network.

### SUMMARY

The present invention provides methods and apparatus, including computer program products, for inline help and performance support for business applications.

In general, in one aspect, the invention features a computer-implemented method including saving captured display screens of a software application, including cursor movement, in one or more files, annotating the captured display screens with objects that can be set to start and stop at pre-defined intervals, combining the captured display screens and annotations to generate a presentation, streaming video objects in the captured display screens from a server system, and generating testing exercises where results can be displayed and saved.

In embodiments, pre-defined computer input keys can perform predetermined actions during an execution of the presentation.

The method can include recording an audio soundtrack to accompany the captured display screens. The method can include adding targeted advertisements to the presentation to be displayed during playback.

The streaming video objects can be streamed over a static background from a network if interconnected computers.

The method can include adding clickable areas of a display screen to the presentation to accept input.

The presentation can include feedback from the testing exercises.

The method can include storing results from the testing exercises in a database.

The presentation can be delivered over an Internet web browser. Audio and video files can be compressed.

In another aspect, the invention features mapping specific fields within a software application to targeted training sessions, defining a single keystroke to enable a user to load the targeted training sessions, exporting a file containing the specific mapped fields for the software application, a target for the training, and a single keystroke needed to enable the targeted training session to load, generating a background service using the exported file, and launching the targeted training session in response to the keystroke.

In embodiments, the background service can be an ASP.NET service. Mapping can include storing an application name, window position, window number, and cursor location. A series of keystrokes can be defined to load the targeted training sessions. A file containing specific mapped fields for the software application, the target for the training, and the keystrokes needed to enable the targeted training session to load can be exported to a server.

The specific mapped fields for the software application, the target for the training, and the keystrokes needed to enable the targeted training session to load can be exported as an Extensible Markup Language (XML) file. The target for the training can be a link to a Hypertext Markup Language (HTML) page containing training material. The background service can be running in memory on a client computer.

After requested, the background service can determine an appropriate mapped field, open a file on a server, and load a selected targeted training session on a client computer. The targeted training sessions can be multimedia presentations.

Other features and advantages of the invention are apparent from the following description, and from the claims.

### BRIEF DESCRIPTION OF THE DRAWINGS

FIG. 1 is a block diagram of a system.

FIG. 2 is a flow diagram.

FIG. 3 is a user interface (UI).

FIG. 4 is a UI.

FIG. 5 is a UI.

FIG. 6 is a UI.

FIG. 7 is a flow diagram.

FIG. 8 through FIG. 36 is a UI.

Like reference numbers and designations in the various drawings indicate like elements.

### DETAILED DESCRIPTION

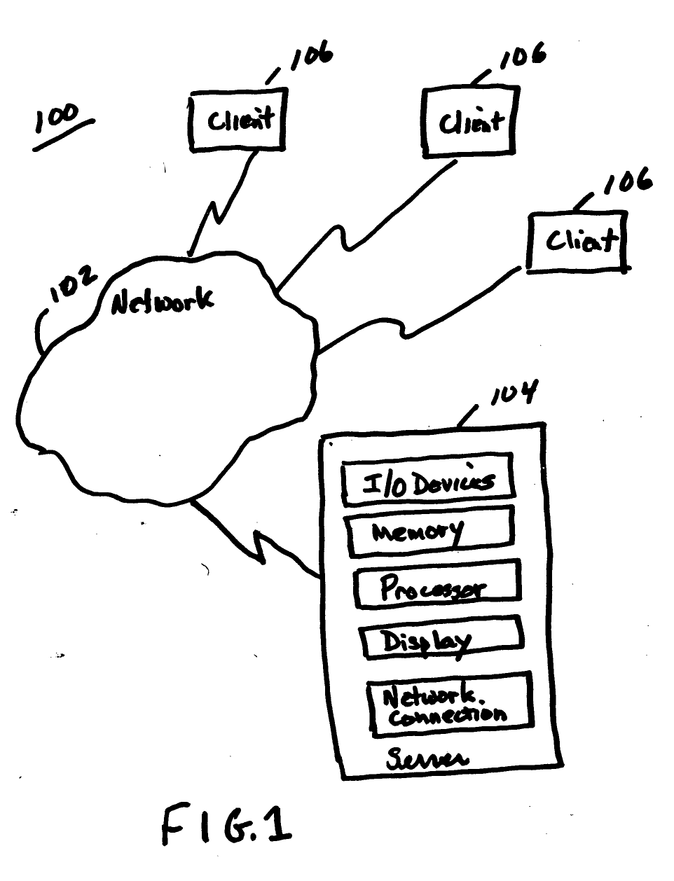

As shown in FIG. 1, an exemplary system 100 is implemented, for example, as a client/server network and includes a server system 104 connected to a network 102 and to one or more client systems 106. The server system 104 and client systems 106 each contain at least an input/output device 108, memory 110, a processor 112, a display 114, and a network connection 116. The server system 104 and client systems 106 communicate with each other through the network 102.

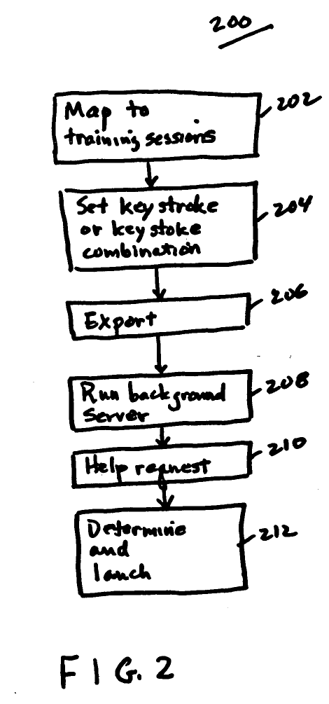

As shown in FIG. 2, a process 200, implemented in memory 110 and executed by the processor 112, provides targeted training for software applications. Cursor locations in display windows of a software application are mapped (202) to specific customized training sessions. The training sessions can provide guidance for various software applications, such as, but not limited to, Microsoft Word® and Microsoft Excel®. Multiple training sessions can be generated for a single software application to handle different aspects of the application. The mapping (202) records a cursor position and a current window of the software application that the cursor is in and allows an association of a specific training session with the position of the cursor in the display window of the software application.

A keystroke or series of keystrokes that are entered to load the training sessions are set (204). When the keystroke or keystrokes are entered, the correct training session loads according to a position of the cursor in a current display window of the software application.

A file is exported (206) onto the server system 104 containing the mapped fields of the software application, the target for the training, and the keystrokes for implementing the training. In one particular example, a target for training can be a link to a hypertext markup language (HTML) page containing training material.

A service executes (208) in memory 110 in the background, on the client system 106 whenever the software application is running. In a preferred embodiment, the background service is an ASP.NET service. ASP.NET is a Microsoft Corporation server-side web technology. ASP.NET is a unified web development platform that provides the services necessary for developers to build enterprise-class web applications. Using ASP.NET, when the defined keystroke or keystrokes are entered (210), the ASP.NET service determines the field in the software application that is currently being accessed. The ASP.NET service opens the exported file to the server system 104. From the information in the opened exported file, the ASP.NET service loads the appropriate training session (212).

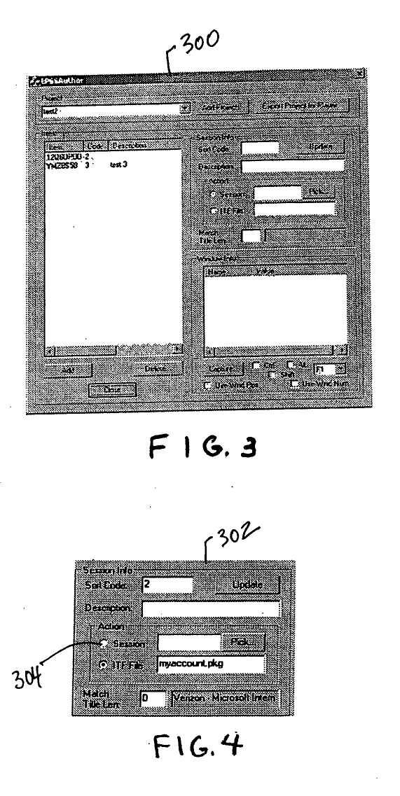

As shown in FIG. 3, an exemplary Graphical User Interface (GUI) 300 enables a user the ability to capture cursor and window positioning for an application software screen. The user simply executes the targeted application software. For each specific field within the application, the user maps the mouse cursor location to a specific customized training session.

The mapping ability records the cursor position for a specific application and allows the user to setup the training session or page to launch for this specific field. The GUI 300 enables an ability to treat projects for mapping of multiple application software programs. In addition, the GUI 300 enables the user to specify exact keystrokes or series of keystrokes to be used for accessing an enhanced help for the application software. This allows the user to use keys or a series of keys that are not already in use for the application, ensuring that the application software launches the enhanced training in place of standard help text.

As shown in FIG. 4, a GUI 302 enables the user an ability to execute customized training topics for any software application and display window. The user does not need to have access to source code for the software application to generate context-specific help for topics with the software application.

A session information area 304 can be highlighted. For each field in the software application, the user can launch a specific, context sensitive, help file by entering the information here. In addition, the user can use area 304 to launch a specific HTML page on the web for a specific, mapped field.

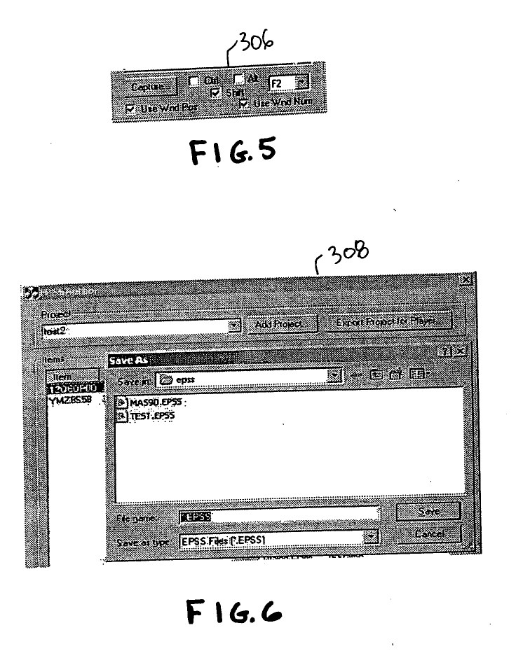

As shown in FIG. 5, using a capture portion of a GUI 306, for each specific area or particular field in a targeted software application, the user can setup a keystroke or combination of keystrokes to display the customized training presentation instead of the standard “canned help” available in the software application.

As shown in FIG. 6, a GUI 308 displays exporting of mapped Business Applications/Fields and customized training information. This exported file is placed on the server system 104 and when the user requests customized help, the business application software, current window, current cursor location and the correct, context-sensitive help file to execute are recognized.

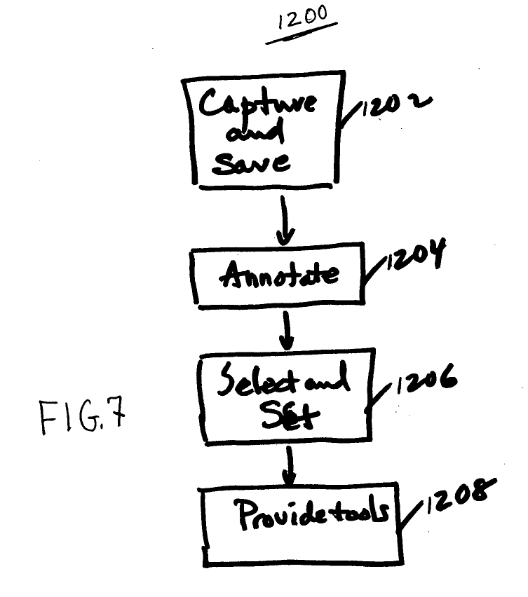

As shown in FIG. 7, a process 1200 for authoring and delivering a multimedia presentation includes capturing and saving (1202) display screens, including cursor movements, from a software application, to generate a presentation. The background of the display screens are saved as static images, while dynamic parts of the display screen, including cursor movements, are saved as video files. The video is compressed into a video media format for delivery. An audio recording can also be saved to provide a synchronized voiceover to along with the presentation. Process 1200 records the audio while saving the screens and cursor movement.

Static background images of the screens are saved as part of the presentation. When the presentation is delivered, the static background images are displayed and overlaid with the compressed video files for the parts of the display screen that are changing, i.e., only the portions of the display screen that are changing are delivered over the network 102 as video files. Because the presentation includes multiple small video files, the presentation can be streamed over a network 102 by server system 104 at a much lower bandwidth than other presentation systems. Because the video files are small in size, multiple video files can be embedded and played simultaneously. During playback of the presentation, the process 1200 delivers those parts of the screen that are dynamic because the video clips are overlaid on a static background image of the software application screen.

The display screens can be annotated 1204 with objects such as text, graphics, images, media clips, and so forth. This enables information to be added to the display screens to enhance the presentation. In a particular example, the presentation can be used as a training tool to teach a user how to use the software application. Annotations can provide helpful tips on how to operate the software application.

After the software application screens have been captured and saved (1202) and a presentation has been generated, objects can be selected (1206) to insert as annotations for the presentation. The annotations are added directly over the captured screens to provide an easy way to target the user's attention to a specific area or function of the software application. The annotations allow for the addition of many types of aides that can further enhance the presentation. The annotations can be given a specific start and stop time. This allows for the annotation to be displayed at a certain specified point during the presentation. The annotations can therefore be synchronized with the rest of the presentation.

Knowledge testing tools can be provided (1208) for the user to complete during or after the presentation. This enables the user to be tested on the content of the presentation. Here the user is learning how to use the software application. The results of the testing tools can be displayed for the user and/or saved into a file for later analysis.

As shown in FIG. 8, a GUI 1220 shows process 1200's video capturing abilities. Process 1200 enables the user an ability to capture the software application display screens without requiring additional software. The capturing ability records the actual display screens and cursor movement of a software application. In addition to the screen capture, while recording, supportive explanations of the software application can be recorded as compressed audio. By recording the actual display screens and movement of the application software, the creator greatly reduces the development time for displaying the media presentation rather than recreating using static display screen shots and multiple audio files. The user can choose audio/video codecs that are best suited for their software application delivery.

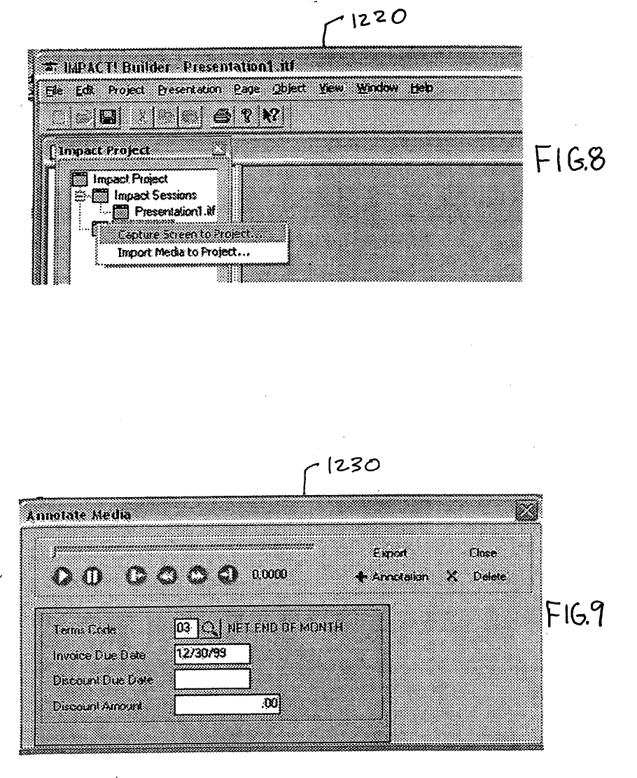

As shown in FIG. 9, a GUI 1230 is used to annotate captured video to enhance a user experience using time-based Annotations. An Annotate button is displayed. Once a recording is performed of application software, the captured video file can be previewed by the developer in a playback window. Depending on the audio and video being displayed, the author can add annotations to the actual application display screen to illustrate the topics being discussed in the training topics. An ability to add these annotations directly over the captured video of the software application enables a developer to target the student's attention to the precise portion of the software application screen that is pertinent for the current training snippet, instead of displaying the entire software application.

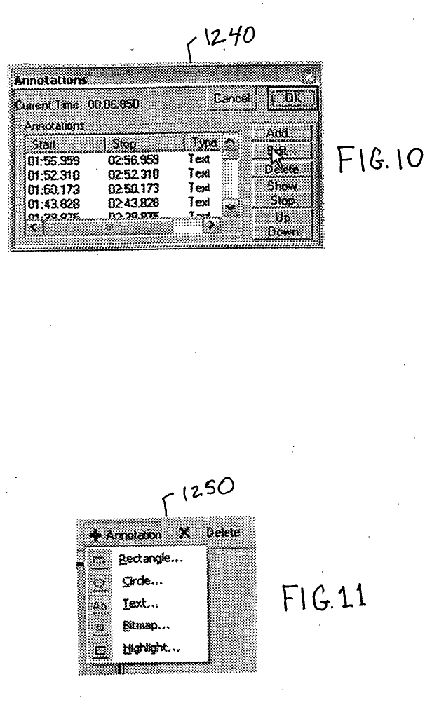

As shown in FIG. 10, an annotation GUI 1240 enables all annotations to be given an exact start and stop time to which this annotation will appear over the captured software application video. The developer can determine at which start and stop time a particular annotation should be shown to precisely synchronize the audio/video and display screen movement of the software application.

As shown in FIG. 11, a GUI 1250 includes the types of annotations that may be inserted into the capture of the software application.

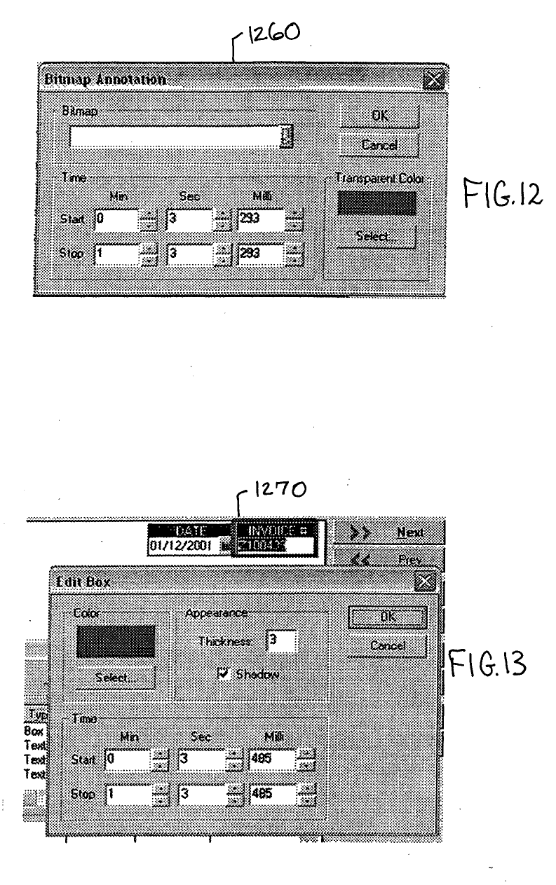

As shown in FIG. 12, a GUI 1260 enables a start and stop the time displayed in minutes, seconds and milliseconds. In addition, a sample of a delivered product illustrating a graphic overlay annotation is displayed. Process 1200 supports multiple standard graphic types such as bitmap image (BMP), windows metafile (WMF), enhanced metafile (EMF), Joint Photographic Experts Group file (JPG; JPEG), and Portable Network Graphics file (PNG), Graphics Interchange Format file (GIF), and so forth. In addition, the user may set a transparency color for the graphic file to ensure seamless overlay on the video output.

As shown in FIG. 13, a box annotation GUI 1270 can be used to emphasize a user defined, rectangular portion of the software application display screen to call the users attention to what is being discussed. A developer has the ability to define color of the outline, size of the line (appearance) and shadowing in addition to the timeline for the annotation.

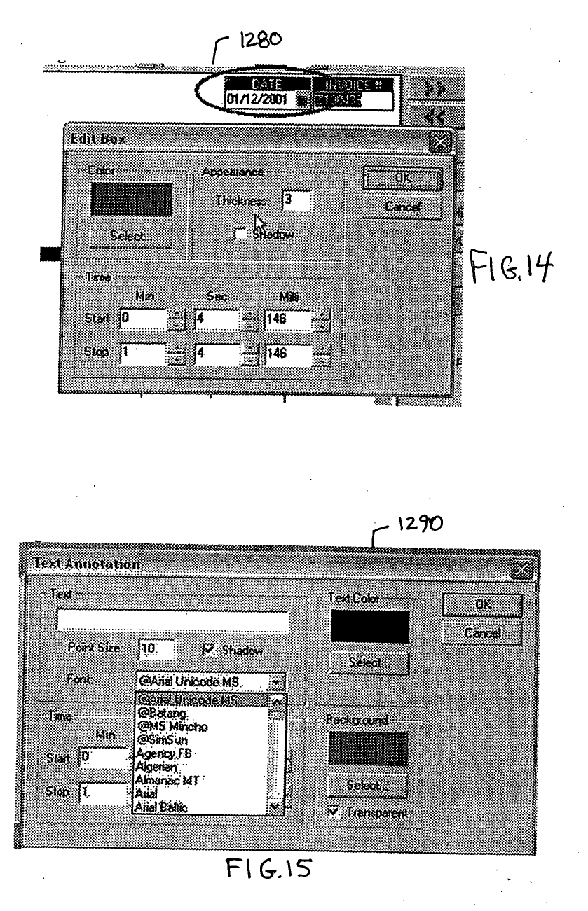

As shown in FIG. 14, a circle annotation GUI 1280 can be used to highlight circular portion of the software application display screen to call the users attention to what is being discussed.

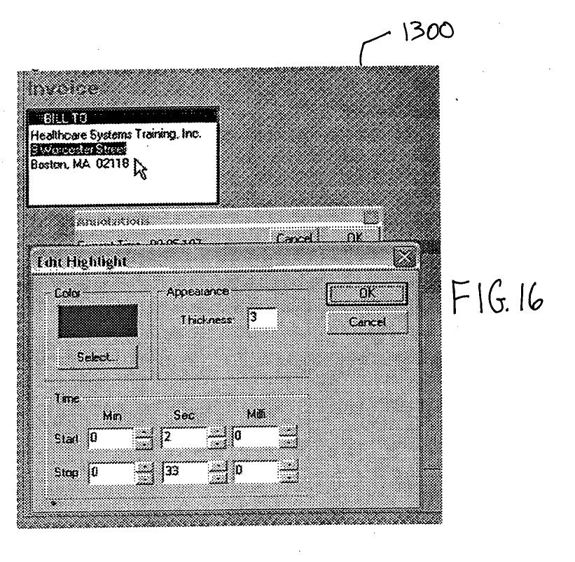

As shown in FIG. 15, a text annotation GUI 1290 can be used to display overlaid text on the video to illustrate the concept being shown. The developer defines the properties of the text such as Point Size, Shadowing, Text and Background color, Font to be displayed and transparency.

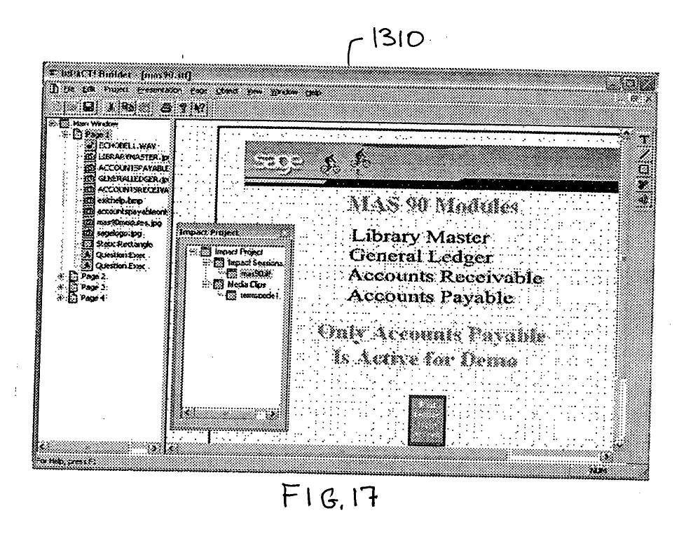

FIG. 16 shows a highlight annotation GUI 1300 and FIG. 17 shows a general builder GUI 1310 that can be used for creating a training package for delivery.

FIG. 18 shows a GUI 1320 and illustrates the types of objects that can be inserted to create the performance support training.

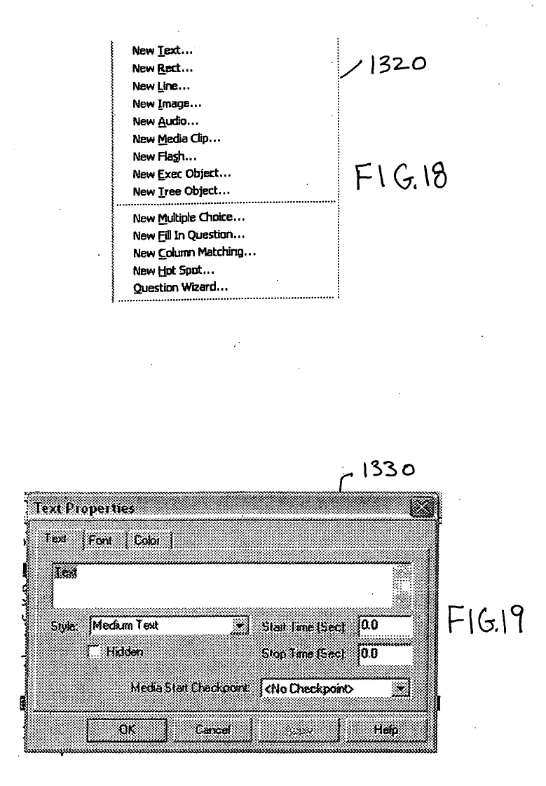

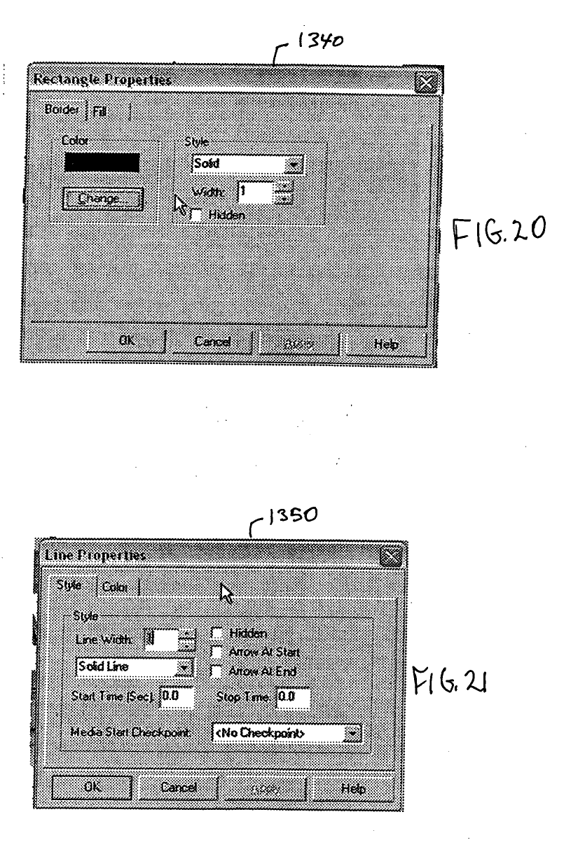

FIG. 19 shows a GUI 1330 that illustrates the Text type of Object. FIG. 20 shows a GUI 1340 that illustrates the Rectangle type of Object. FIG. 21 shows a GUI 1350 that illustrates the Line type of Object. FIG. 22 shows a GUI 1360 that illustrates the Graphic Type of Object.

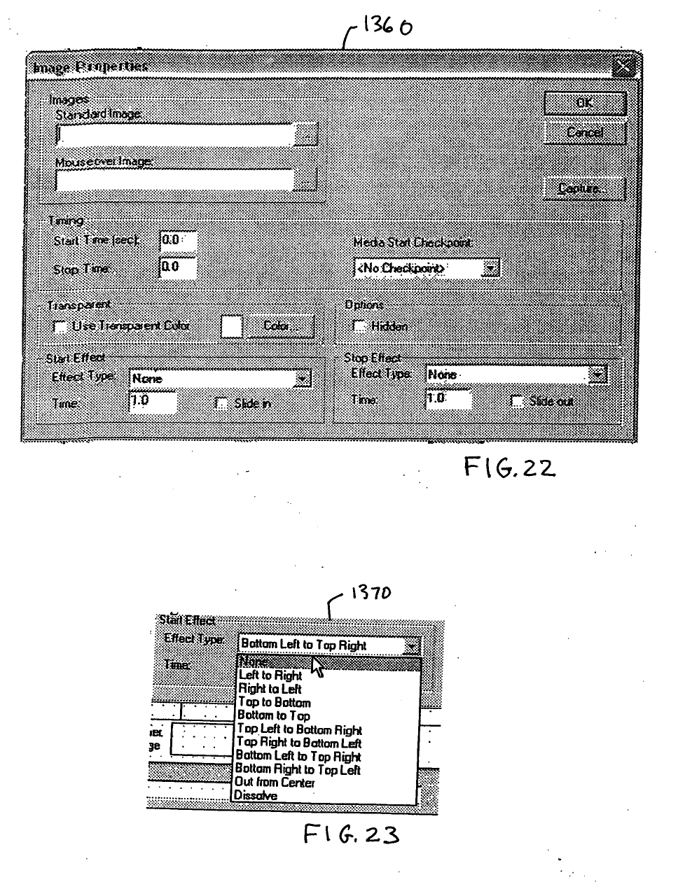

As shown in FIG. 23, a GUI 1370 shows the Effects that can be added to graphic displays. Effects can be shown both at the Start Time for the Graphic and the Stop Time to make the presentation more interesting to the user.

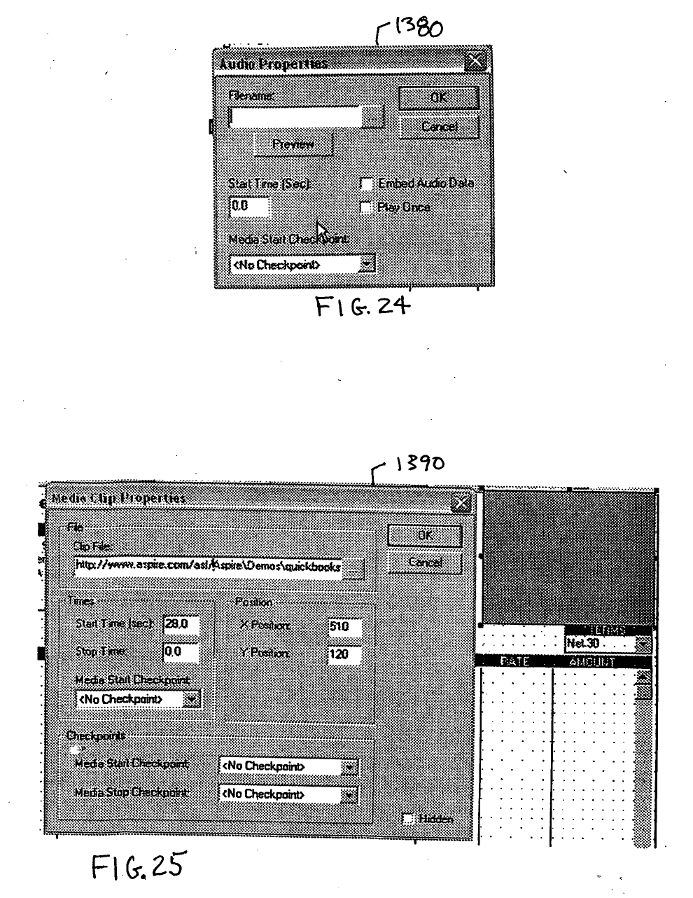

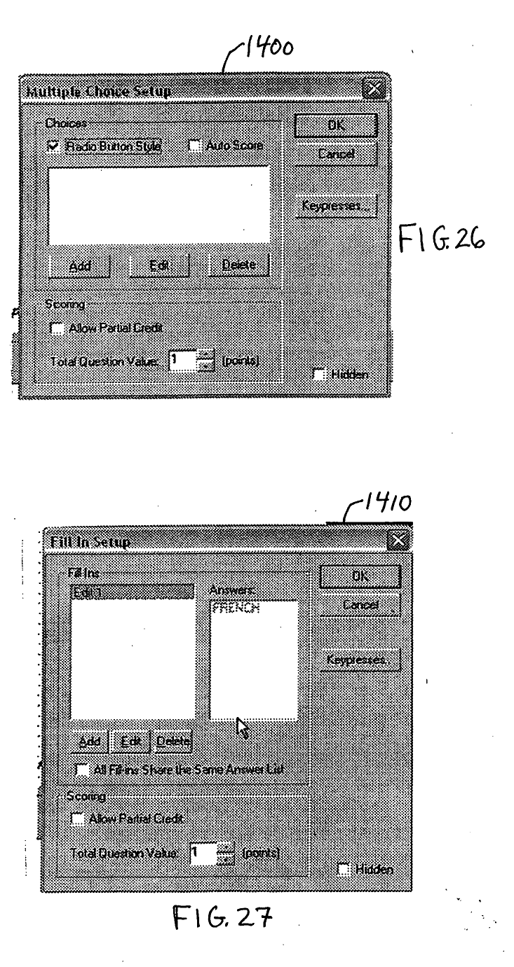

FIG. 24 shows a GUI 1380 that illustrates the Audio Type of Object. Audio files can be wave file (WAV), MPEG-1 Audio Layer-3 file (MP3) or windows media audio file (WMA) embedded into the compressed delivery file or the audio can be streamed from a Multimedia server over the web. Any text/graphic/box/line and Media Clip objects are linked to the overlaid audio object to synchronize the playback.

FIG. 25 shows a GUI 1390 that illustrates the Media Clip type of Object. Small, streaming pieces of encoded video are placed on the background graphic to enable only delivery of those pieces of video that are dynamic. These media clips are streamed from a web server in real time. This approach of integrating streamlined Media Clip objects into the whole of the presentation instead of saving video files in the presentation package greatly reduces the file sizes of the compressed training package for delivery using the Internet. This compressed, streaming media object enables an ability to deliver Full Screen Application Software training over low bandwidth connections. It also enables multiple media clip objects to be embedded and synchronized on an individual page of the presentation to enable the developer complete control to display the application software without restrictions currently placed on playing single, one at a time media clips and other streaming delivery applications such as browsers. To support the ability to place multiple streaming media objects in addition to graphics, text, audio, and so forth, on a single page, and synchronize the playback of all of the objects, the process 1200 enables factoring of network latency, Internet delivery, buffering time, and so forth. Through a use of Checkpoints, the developer has the ability to make the timing of all objects on the page (to include multiple streaming video sources) relative to the delivery time of the other objects rather than to the absolute time of the object or video being served. This use of relative times based on the real time delivery of the objects on the page ensures that the playback of all objects remains in synch.

FIG. 26 shows a GUI 1400 that illustrates the Multiple Choice type of Object. In addition to providing rich multimedia presentations of software applications, process 1200 enables the developer the opportunity to produce knowledge assessment using built-in objects. These objects are displayed during playback and captured, and user input to the objects for analysis and knowledge management is stored.

FIG. 27 shows a GUI 1410 that illustrates the Fill In type of Object.

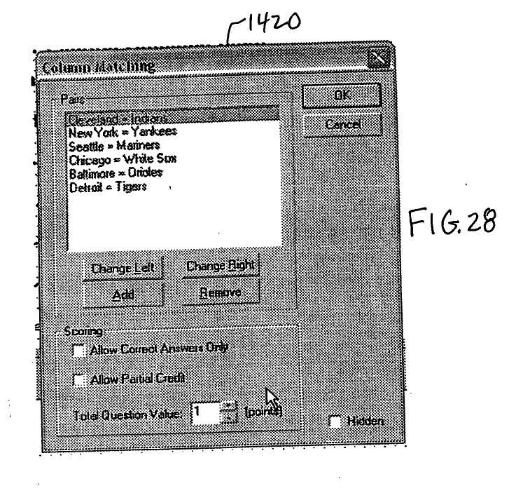

FIG. 28 shows a GUI 1420 that illustrates a Column Matching type of Object. This type of object enables the developer to create columns of questions and answers. During playback, input from the user is accepted using the mouse cursor. The user matches the question from column A to the answers in column B.

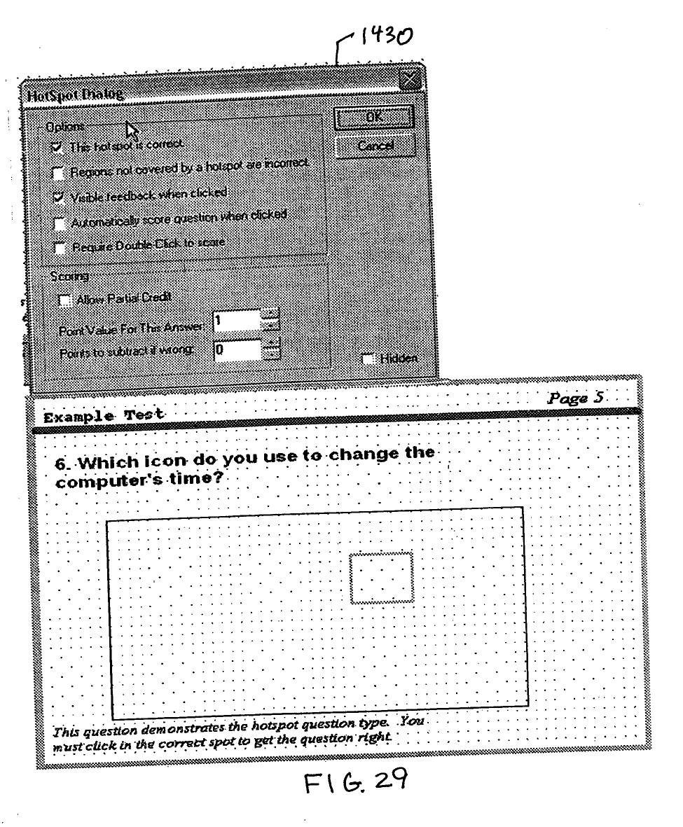

FIG. 29 shows a GUI 1430 that illustrates a Hotspot type of Object. The developer defines a clickable area of the playback screen. When a user clicks this area, the predefined command is performed. The hotspots can be defined as “correct,” “incorrect” or require double clicking of the mouse button by the user. In addition, visible Feedback screens can be created to be display based on the user input to the hotspot object.

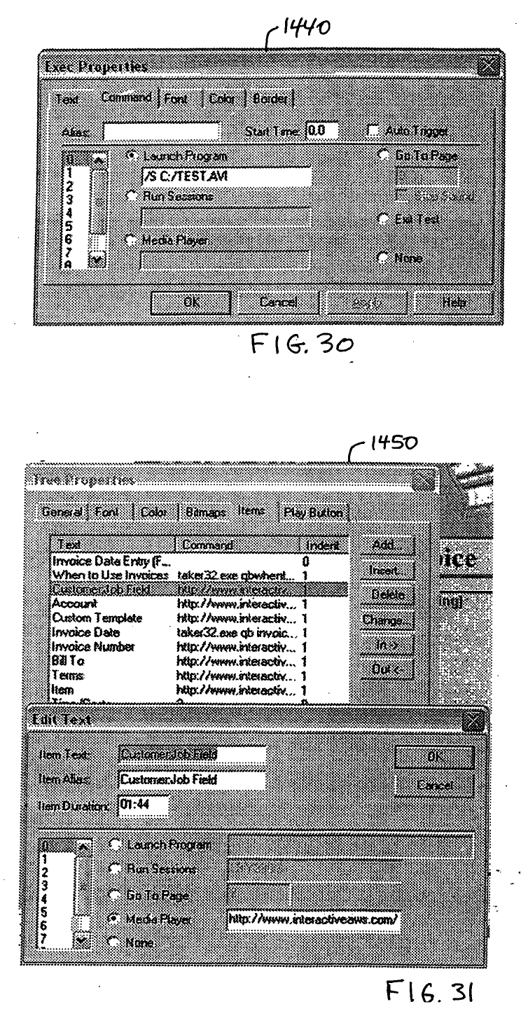

FIG. 30 shows a GUI 1440 that illustrates an Exec type of Object. This powerful type of object is used to accept user input by a pointing device. When a user clicks on an exec object during playback, multiple predetermined actions can be performed, including chaining different actions to be performed and an order in which they are performed. Actions include launching a program, advancing to another page in the presentation, launching a streaming media presentation or exiting the test. The exec object can be used to launch a web site, display animated graphics, and so forth, for targeted Advertising within the playback of the multimedia session. In addition, an Exec object can be auto-triggered based on the Start Time in the timeline. Exec objects can be setup as text, similar to a hyperlink, or may be positioned over other graphics to create a ‘clickable ’ area to accept user input. Once the user inputs a signal, the desired actions are performed. The developer customizes all fonts, Colors and Borders for the exec object.

FIG. 31 shows a GUI 1450 that illustrates a Tree type of Object. This object is used to combine multiple exec types to display short, concise training snippets to the user. Each individual item on the tree may be linked for playback. Graphics may be used to illustrate when a tree item is expanded or imploded. For example, a picture of a closed book or an open book to indicate the items expanded. In this manner, sessions can be tied to the larger lessons and courses.

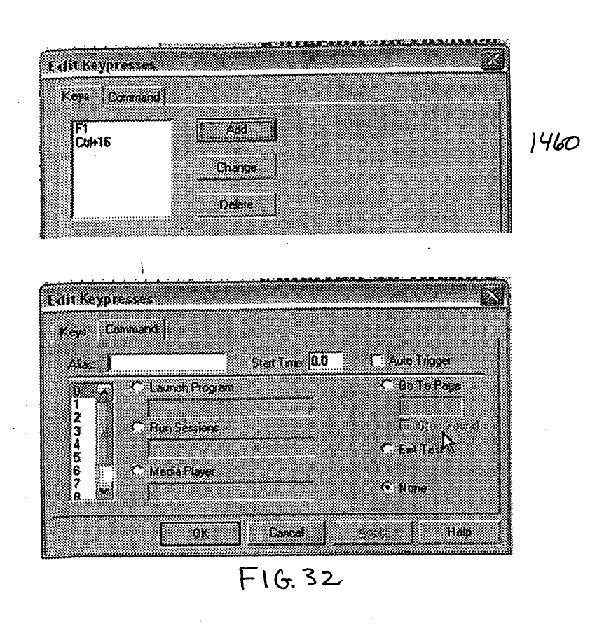

FIG. 32 shows a GUI 1460 that illustrates a Key Press Object. This type of object enables the developer to setup certain computer keystrokes, that when pressed by the user during playback, invokes a command to be performed.

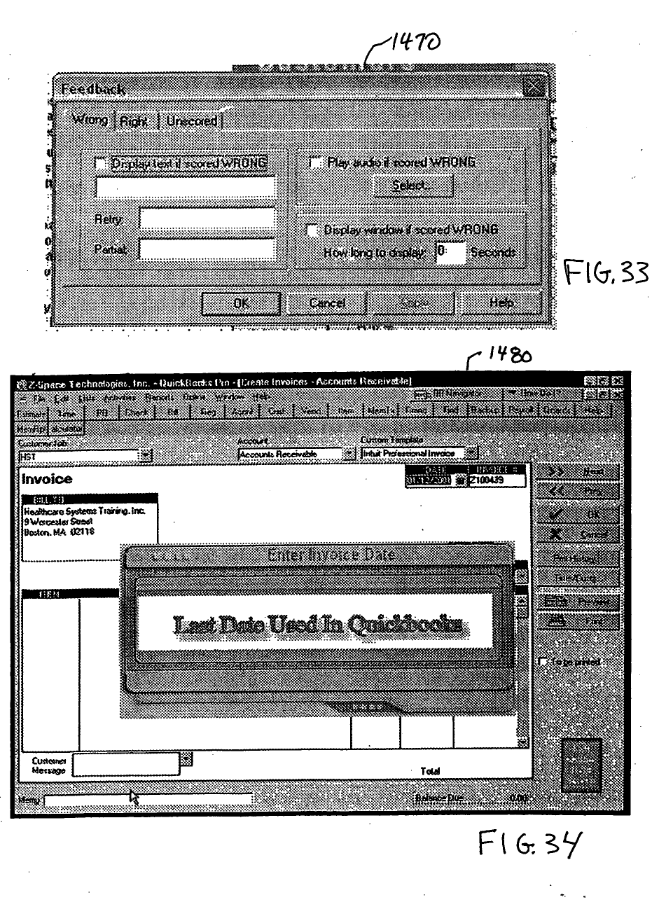

FIG. 33 shows a GUI 1470 that illustrates Feedback. Feedback screens can be used during playback to inform the user of their knowledge testing. Different feedback screens can be setup to be displayed depending on whether a response is judged Wrong, Right or un-scored. The developer also has the ability to insert an audio file based on feedback and can setup the amount of time the feedback should display.

FIG. 34 shows a GUI 1480 that illustrates a screen shot of the actual presentation created, highlighting the background static graphic of the software application as well as the ability to stream multiple videos in specific regions of the screen with synchronized audio/text/graphics. The small, compressed presentation file is downloaded and opened using ActiveX or a plug-in. The full screen of the software application is displayed and all of the text, graphics and audio are displayed according to the timeline developed. Since, all video files are streamed from the web in small, incremental pieces only for those portions of the screen that are dynamic, the training can be displayed in full screen and the streaming portion can be delivered with low bandwidth.

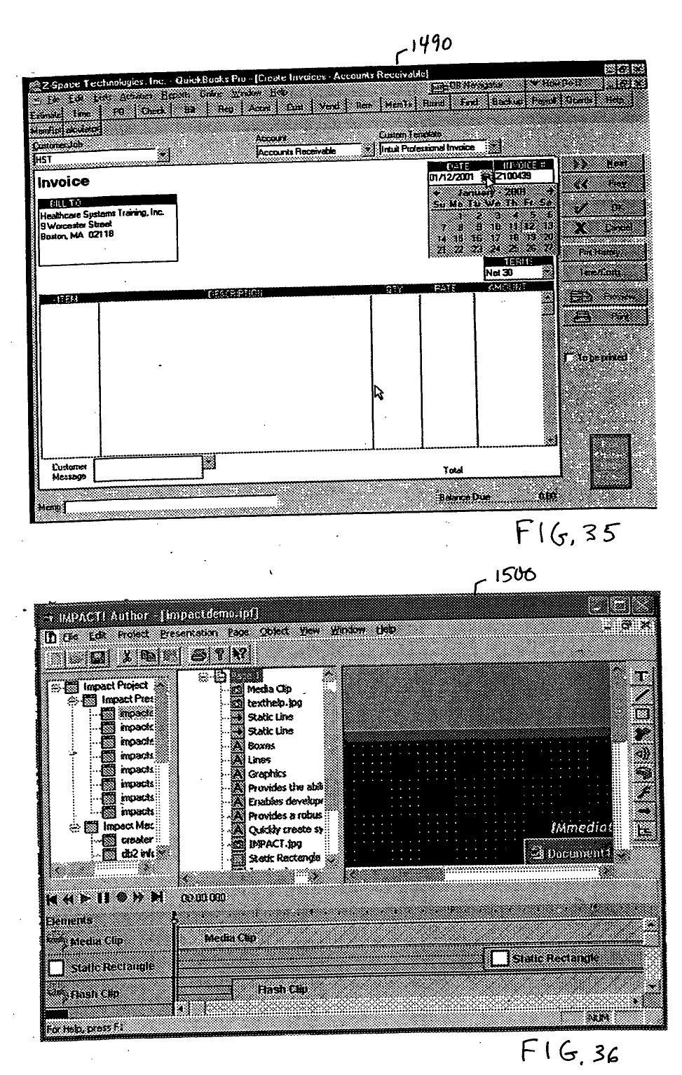

FIG. 35 shows a GUI 1490 that illustrates the embedded proprietary ActiveX for delivering the training to the user. FIG. 36 shows a GUI 1500 that illustrates IMPACT's User Interface (Ul) for creating presentations.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
saving captured display screens of a software application, including cursor movement, in one or more files;
annotating the captured display screens with objects that can be set to start and stop at pre-defined intervals;
combining the captured display screens and annotations to generate a presentation;
streaming video objects in the captured display screens from a server system; and
generating testing exercises where results are displayed and saved.

2. The computer-implemented method of claim 1 wherein pre-defined computer input keys can perform predetermined actions during an execution of the presentation.

3. The computer-implemented method of claim 1 further comprising recording an audio soundtrack to accompany the captured display screens.

4. The computer-implemented method of claim 1 further comprising adding targeted advertisements to the presentation to be displayed during playback.

5. The computer-implemented method of claim 1 wherein the streaming video objects are streamed over a static background from a network if interconnected computers.

6. The computer-implemented method of claim 1 further comprising adding clickable areas of a display screen to the presentation to accept input.

7. The computer-implemented method of claim 1 wherein the presentation comprising feedback from the testing exercises.

8. The computer-implemented method of claim 1 further comprising storing results from the testing exercises in a database.

9. The computer-implemented method of claim 1 wherein the presentation is delivered over an Internet web browser.

10. The computer-implemented method of claim 3 wherein audio and video files are compressed.

11. A computer-implemented method comprising:
mapping specific fields within a software application to targeted training sessions;
defining a single keystroke to enable a user to load the targeted training sessions;
exporting a file containing the specific mapped fields for the software application, a target for the training, and a single keystroke needed to enable the targeted training session to load;
generating a background service using the exported file; and
launching the targeted training session in response to the keystroke.

12. The computer-implemented method of claim 11 wherein the background service is an ASP.NET service.

13. The computer-implemented method of claim 11 wherein mapping comprises storing an application name, window position, window number, and cursor location.

14. The computer-implemented method of claim 11 wherein a series of keystrokes are defined to load the targeted training sessions.

15. The computer-implemented method of claim 11 wherein a file containing specific mapped fields for the software application, the target for the training, and the keystrokes needed to enable the targeted training session to load is exported to a server.

16. The computer-implemented method of claim 11 wherein the specific mapped fields for the software application, the target for the training, and the keystrokes needed to enable the targeted training session to load are exported as an Extensible Markup Language (XML) file.

17. The computer-implemented method of claim 11 wherein the target for the training is a link to a Hypertext Markup Language (HTML) page containing training material.

18. The computer-implemented method of claim 11 wherein the background service is running in memory on a client computer.

19. The computer-implemented method of claim 11 wherein, after requested, the background service determines an appropriate mapped field, opens a file on a server, and loads a selected targeted training session on a client computer.

20. The computer-implemented method of claim 11 wherein the targeted training sessions are multimedia presentations.
